(19) United States
(12) Patent Application Publication
(10) Pub. No.: US 2007/0149046 A1
(43) Pub. Date: Jun. 28, 2007

(54) Card connector

(75) Inventors: Gong-Qing Yang, ShenZhen (CN); Chang-Shin Hsu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/645,432

(22) Filed: Dec. 26, 2006

(30) Foreign Application Priority Data
Dec. 23, 2005 (CN) 200520140220.0

(51) Int. Cl. H01R 13/60

(52) U.S. Cl. 439/570

(57) ABSTRACT

A card connector comprises insulating housing comprising a plurality of passageways; a plurality of contacts received in the passageways of the housing; and metal ears received on the housing; wherein the metal ear has legs extends on an upper surface and a bottom surface of the housing respectively to engage the metal ear on the housing and one of the legs is used to solder the metal ear on a PCB.

### BACKGROUND OF THE INVENTION

1. Field of the Invention

The present invention is generally related to a card connector, and especially to a connector for connecting with a SIM (Subscriber Identity Module) card.

2. Description of Related Art

Conventional electrical SIM card connector is disclosed in U.S. Pat. No. 6,086,424. The connector includes a rectangular housing defining two sets of the three contact passages extending from two opposite sides of the housing toward a middle portion thereof, respectively. Six contacts are fixedly received in the corresponding contact passageways by interferentially engaging fitting portions of the contacts with the housing, wherein each fitting portion has a slit formed therein so that each fitting portion is compressed by the housing when it is inserted into the corresponding contact passageway.

However, The conventional connector is mounted on the PCB (Print Circuit Board) by soldered solder portions of the contacts on the board. The housing of the connector has not been mounted on the board. So the connector can not mounted on the PCB securely.

Hence, an improved card connector is highly desired to overcome the aforementioned disadvantages of the prior art.

### SUMMARY OF THE INVENTION

Accordingly, an object of the present invention is to provide a SIM card connector which has secure and simple soldering structure for securing the connector on PCB.

To achieve the above object, a card connector comprises insulating housing comprising a plurality of passageways; a plurality of contacts received in the passageways of the housing; and metal ears received on the housing; wherein the metal ear has legs extends on an upper surface and a bottom surface of the housing respectively to engage the metal ear on the housing and one of the legs is used to solder the metal ear on a PCB.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled perspective view of the card connector in accordance with the present invention;

FIG. 2 is an exploded, perspective view of the card connector of FIG. 1;

FIG. 3 is an exploded, perspective view of the card connector of FIG. 2, but from another aspect;

FIG. 4 is assembled perspective view of the card connector of FIG. 1, but the metal ear is not assembled.

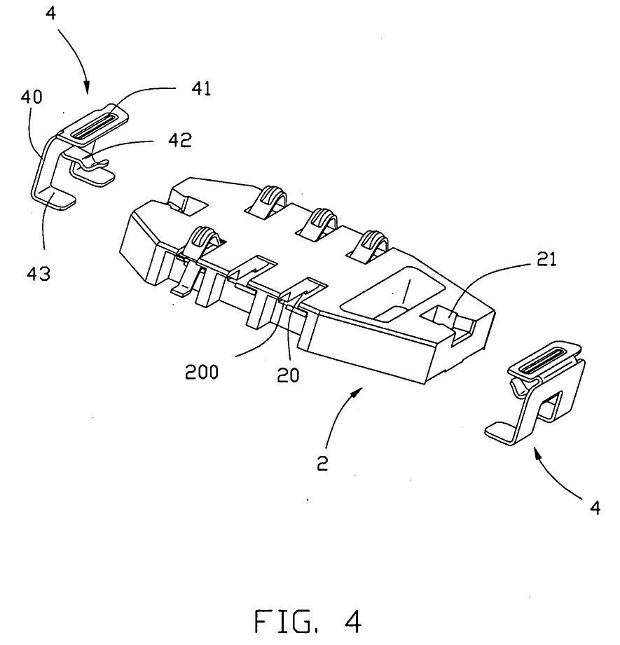

### DETAILED DESCRIPTION OF THE INVENTION

Reference will now be made in detail to the preferred embodiment of the present invention.

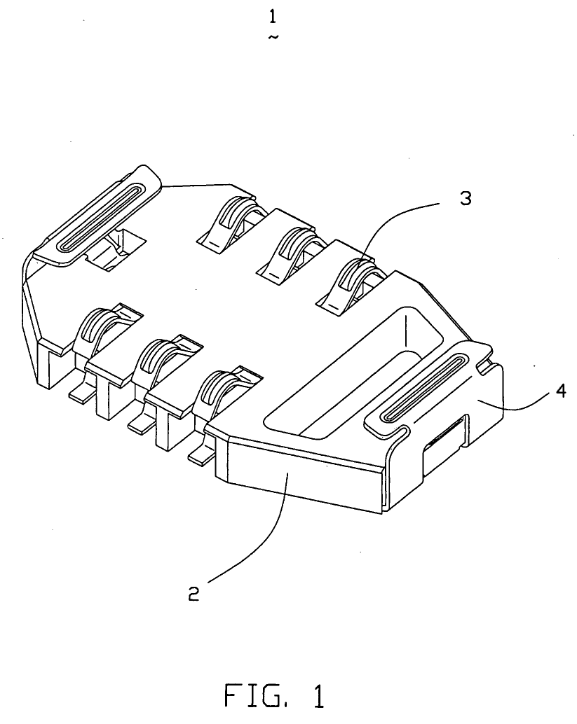

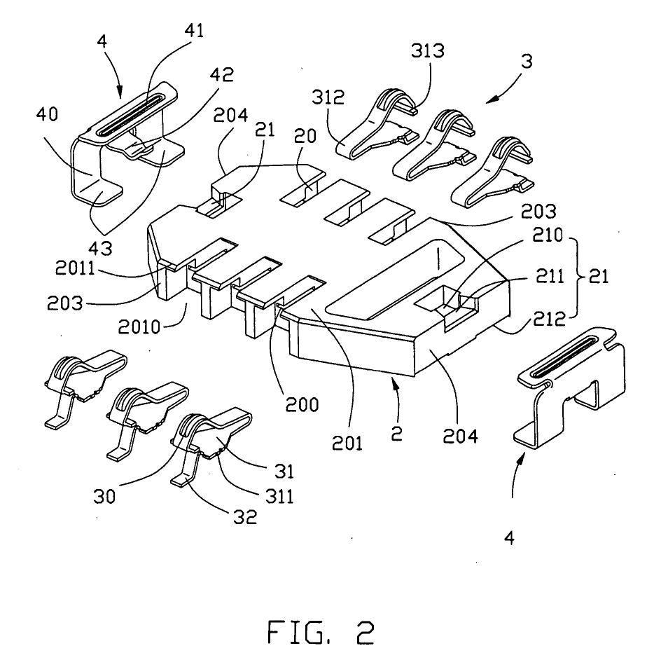

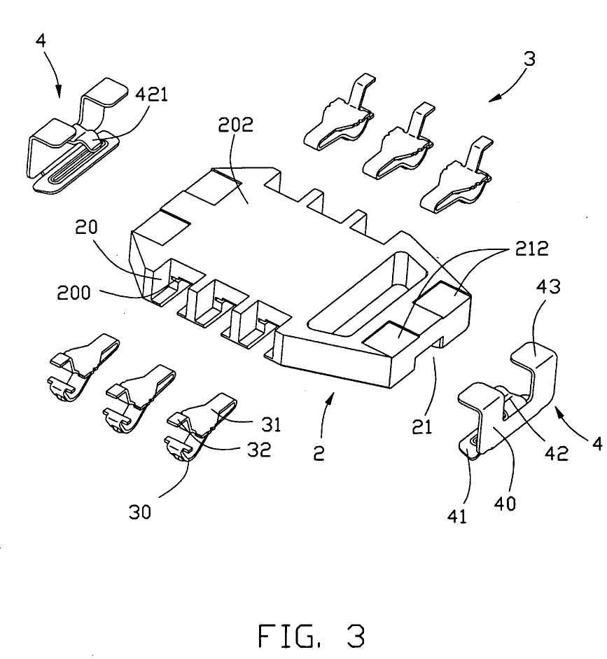

Referring to FIGS. 1-3, a SIM card connector 1 in accordance with the present invention includes a shuttle-shaped housing 2, Two sets of three contacts 3 and a pair of metal ears 4. The housing 2 has a top surface 201 for proximity to a SIM card (not shown), a bottom surface 202 for proximity to a printed circuit board, two opposite longitudinal sides 203 and two opposite lateral sides 204 between the top and bottom surfaces 201, 202. Two sets of three contact passageways 20 are defined in the top surface 201 and extend from the two longitudinal sides 203 toward a middle portion of the housing 2, respectively. Each contact passageway 20 defines a depression portion 2010 which forms stops 2011 thereabove and a channel portion 200 therein.

The housing 2 further defines a pair of engaging portions 21 on two the lateral sides 204 of the housing 2 respectively. Each engaging portion 21 comprises an upper engaging portion formed on the top surface 201 and a bottom engaging portion 212 formed on the bottom surface 202, the upper engaging portion is formed in a middle of the lateral side 204 of the housing 2 and includes an outer recess 211 having flared inlet and an inner recess 210 having a bottom surface lower than the outer recess 211 to form a step between recesses 211, 210. The bottom engaging portion 212 is formed on the bottom surface 202 and is formed of a pair of recesses on two sides of the upper engaging portion.

Two sets of three contacts 3 are mounted into the corresponding contact passageways 20. Each contact 3 has a fitting portion 31 with barbs 311 on two longitudinal sides thereof. A soldering portion 32 extends below and rearward from the fitting portion 31 for mounted on a PCB (not show). An arced bridging section 312 extends in front of the corresponding fitting portion 31 to connect with a corresponding contact portion 30 for engaging with the SIM card (not shown). The contact portion 30 is located above the fitting portion 31 and is terminated at an enlarged free end 313 thereof.

The metal ear 4 comprises a vertical base portion 40, a top horizontal leg 41 extending from the base portion 40, a middle horizontal leg 42 and a pair of bottom horizontal legs 43 each extending from the base portion 40 corresponding to the engaging portion 21. The middle leg 42 has a curved portion 421 corresponding to the recess 210.

To assemble the connector 1, the two sets of contacts 3 are successively mounted into the contact passageways 20 by extending the fitting portions 31 into the corresponding channels 200 to reach a position in which the fitting portions 31 are located in the corresponding contact passageways 20 and compressed by the housing 2. The free ends 313 of the contact portions 30 are retained by the corresponding stops 2011 above the corresponding depression portions 2010 to obtain a preload therein. The contact portions 30 project beyond the top surface 201 of the housing 2. The metal ears 4 are mounted on two lateral sides of the housing 2, wherein the top leg 41 and bottom legs 43 are mounted on the top surface 201 and the bottom surface 202 respectively and the middle leg 42 is extended into the engaging portion 21 with the curved portion 421 extended in the inner recess 210 and received into the step. The base portion 40 is aligned with the side of the housing 2. The step formed between the inner and outer recesses 210, 211 prevents the metal ear from horizontal movement. And the top and the bottom legs are mounted on the surfaces of the housing to prevent the metal ear 4 from vertical movement.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector for mounted on a PCB (Print Circuit Board), comprising:
an insulating housing comprising a plurality of passageways;
a plurality of contacts received in the passageways of the housing; and
metal ears received on the housing;
wherein each metal ear has legs extending on an upper surface and a bottom surface of the housing respectively to engage the metal ear on the housing and one of the legs is used to solder the metal on a PCB.

2. The card connector as described in claim 1, wherein the contacts are mounted on two opposite longitudinal sides and metal ears are mounted on two opposite lateral sides of the housing respectively.

3. The card connector as described in claim 1, wherein the housing further has a recess formed on the upper surface and the metal ear has a leg portion extended on the recess for engaging the metal ear on the housing.

4. The card connector as described in claim 3, wherein the recess has an outer recess and an inner recess with a step formed therebetween, the leg portion further has a curved portion extending into the recess and secured by the step.

5. The card connector as described in claim 4, wherein the outer recess has a flared inlet and the inner recess has a bottom surface lower than the outer recess to form the step between recesses.

6. The card connector as described in claim 3, wherein legs mounted on the bottom surface is extended on recesses formed on the bottom surface of the housing.

7. The card connector as described in claim 1, wherein the metal ear further has a base portion aligned with the lateral side of the housing and the legs extend from the base portion.

8. A card connector comprising:
an insulative housing defining an upward upper face;
a pair of metallic guiding arms assembled to two opposite lateral side of the housing, and having top flanges extending toward each other but terminated and spaced from each other with a distance in a lateral direction of the housing;
a card receiving space being defined below the top flanges of the guiding arms and above the upper face of the housing; and
a plurality of contacts each having a contact portion upwardly extending beyond the upper face and into the card receiving space.

9. The card connector as claimed in claim 8, wherein said contacts defines a contact area on the upper face of the housing, and said flange is located outside of said contact area.

10. The card connector as claimed in claim 8, wherein the contact portion essentially extends along a front-to-back direction, along which a card is inserted into or withdrawn from the receiving space, perpendicular to said lateral direction.

11. The card connector as claimed in claim 8, wherein the guiding arm defines a vertical section directly facing the card receiving space for directly guiding an inserted card.

12. The card connector as claimed in claim 9, wherein the contact area defines a first dimension in said lateral direction and a second dimension in a front-to-back direction along which a card is inserted into or withdrawn from the card receiving space, said first dimension being larger than the second dimension.

13. The card connector as claimed in claim 12, wherein each of said guiding arms defines along the front-to-back direction a dimension smaller than the second dimension so as to maintain a compact arrangement of the guiding arms with regard to the housing.

14. The card connector as claimed in claim 8, wherein the whole housing extends in a planar manner.

15. The card connector as claimed in claim 8, further including complementary interengagement devices on both the guiding arms and lateral sides of the housing, which are configured and dimensioned to allow the guiding arms are only horizontally and inwardly assembled and retained to the corresponding lateral sides of the housing from an exterior, respectively,

16. The card connector as claimed in claim 8, wherein the lateral sides of the housing define some recessed region to receive corresponding portions of the corresponding guiding arms, respectively.

17. The card connector as claimed in claim 18, wherein said contacts are arranged in two rows along the lateral direction, and the guiding arm is essentially symmetrical with regard to a center line between said two rows of the contacts.

18. The card connector as claimed in claim 18, wherein the contact portions of said contacts in two rows are arranged in a mirror image with each other.
